(19) United States
(12) Patent Application Publication
(10) Pub. No.: US 2007/0242785 A1
(43) Pub. Date: Oct. 18, 2007

(54) Radiating Device Comprising at Least One Adaptive Rejection Filter and Antenna Provided with Said Device

(76) Inventors: Franck Thudor, Rennes (FR); Jean-Luc Robert, Betton (FR); Jean-Yves Le Naour, Pace (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/628,603

(22) PCT Filed: Jun. 7, 2005
(86) PCT No.: PCT/EP05/52618

§ 371 Date: Dec. 5, 2006

(30) Foreign Application Priority Data
Jun. 9, 2004 (FR) 0451147

(51) Int. Cl. H04B 1/10

(52) U.S. Cl. 375/350

(57) ABSTRACT

This invention relates to an antenna comprising at least one radiating device, furnished with a rejector filter associated with a frequency band of an interfering signal. In accordance with the invention, such an antenna is characterized in that this rejector filter is adaptive, so as to be active when the interfering signal is detected and its power is above a threshold, this adaptive filter being deactivated when the detected power of this interfering signal is below the threshold.

The present invention pertains to a radiating device comprising at least one adaptive rejector filter and to an antenna comprising this device. This invention applies in particular in wireless communications using high frequencies.

Today, there exist numerous wireless communication techniques for the transmission of digital data. The majority of the conventional techniques consist in modulating a high-frequency carrier via these digital data.

The resulting signal is thereafter amplified then transmitted to the transmitting antenna. On reception, the inverse operation is carried out.

Other information transmission techniques exist, in particular a technique relying on the emission of Gaussian pulse trains of very short duration (of the order of 500 ps) the recurrence of which is accurately checked. The useful information to be transmitted is contained in the evolution of the period between the consecutive pulses.

This communication technique is called pulse position modulation (PPM). It allows carrier-less transmission of data at high-throughput with relatively low emission powers (less than a milli-Watt), the waveform of the pulse used leading to a signal having a very wide band in the frequency domain.

Standardization bodies are currently creating a UWB (“Ultra Wide Band”) standard on the basis of this PPM technique.

These bodies have already adopted limitation criteria both at the level of power emitted and also frequency congestion so as to reduce the possibilities of interference with the numerous means of communication already deployed.

Thus, the frequency span reserved for UWB wireless communications has been limited to [3.1 GHz; 10.6 GHz] with a maximum Equivalent Radiated Isotropic Power (ERIP) of −41 dBm/Mhz i.e. −2.25 dBm on the permitted bandwidth.

But a significant problem arises with certain wireless transmission systems using a part of the allocated frequency band, in particular between 5 GHz and 6 GHz.

Thus, other standards, in particular Hyperlan2 and 802.11a, have allocated bands of

[5.15 GHz; 5.35 GHz] and [5.47 GHz; 5.725 GHz] in Europe,

[5.15 GHz; 5.35 GHz] and [5.725 GHz; 5.825 GHz] in the United States,

[5.15 GHz; 5.35 GHz] in Japan.

Such systems are potential disturbers for a UWB receiver since they can exhibit signal powers much greater than the normalized powers in the UWB standards.

These disturbers are therefore penalizing in respect of UWB devices since they emit interfering signals in respect of these devices and decrease their passband.

Specifically, in the presence of such a disturbing system, the amplifier of signals having low powers (dubbed LNA, the initials standing for “Low Noise Amplifier”) and the converter of the analogue signals into digital signals (dubbed ADC) of UWB devices are saturated. This causes the UWB pulse not to be correctly detectable.

It is known to filter certain frequencies so as to protect a device at reception or to disable emissions of a device so as not to interfere with existing communications moreover by means of rejector filters for the frequency bands where there may be interference.

The present invention stems from a finding specific to the invention according to which these rejector filters permanently decrease the passband of the devices with which they are associated, while the interfering signals are not necessarily permanent, or even do not exist.

The present invention solves at least the problem cited above, namely the continuous presence of the rejector filter and therefore the penalizing decrease in passband corresponding to this filter, even in the absence of interfering signals.

The invention relates to an antenna comprising at least one radiating device, furnished with a rejector filter associated with a frequency band of an interfering signal, characterized in that this rejector filter is adaptive, so as to be active when the interfering signal is detected and its power is above a threshold, this adaptive filter being deactivated when the detected power of this interfering signal is below the threshold.

By virtue of the invention, the rejector filter of the antenna is activated, in a dynamic and adaptive manner, only when a power or intensity, above a certain threshold, of interfering signal is detected.

Such an antenna presents the advantage of being in this case protected on reception and of not interfering with the interfering signals on transmission.

In particular, the saturation of the converter of the analogue signals into digital signals in the presence of interfering signals is avoided.

Moreover, such an antenna also presents the advantage of not having its passband limited in the absence of interfering signals.

In fact, in the absence of an interfering signal or if the intensity of this signal drops back below a certain threshold, the rejector filter is deactivated and the passband of the antenna is not reduced.

The rejector filter can be integrated within the antenna, leading to limited insertion losses, improved compactness for the antenna and reduced cost for the antenna.

The noise factor problems related to the integration of the filters between the antenna and the converter of analogue signals into digital signals are eliminated by this invention.

In an embodiment, the antenna is able to receive or to transmit signals in the frequency band of [3.1 GHz; 10.6 GHz].

According to an embodiment, the rejector filter comprises at least one nonconducting part in the radiating device.

In an embodiment, the nonconducting part has a dimension equal to half the central wavelength of an interfering signal that it is desired to filter for reception or to protect for transmission, if this signal is detected.

According to an embodiment, the nonconducting part is bridged by switching means linking its conducting edges.

In an embodiment, the switching means comprise a diode or an electromechanical system.

According to an embodiment, means of detection of an interfering signal are associated with the antenna.

In an embodiment, the means of detection comprise at least one comparator for comparing the level of the interfering signal with the threshold associated with this signal.

According to an embodiment, means of control of the switching means are associated with the antenna.

In an embodiment, the control means open the switching means associated with an interfering signal when the power of this interfering signal exceeds the threshold associated with this signal.

According to an embodiment, the control means close the switching means associated with a certain interfering signal when the power of this interfering signal drops below the threshold associated with this signal.

In an embodiment, the antenna is embodied on a printed circuit.

According to an embodiment, the radiating device is a dipole comprising two radiating elements.

In an embodiment, the radiating elements have a circular or elliptical shape.

According to an embodiment, the radiating device comprises at least two rejector filters.

The invention also relates to a radiating device, furnished with a rejector filter, characterized in that the rejector filter is adaptive so as to be implemented in an antenna according to one of the preceding embodiments.

Other characteristics and advantages of the invention will appear with the description given below by way of nonlimiting example while referring to the appended figures in which:

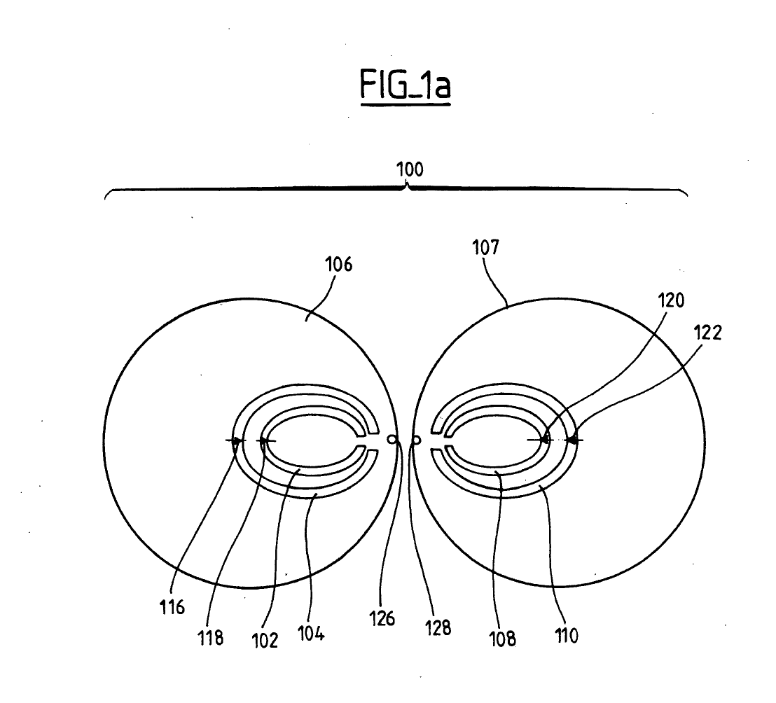

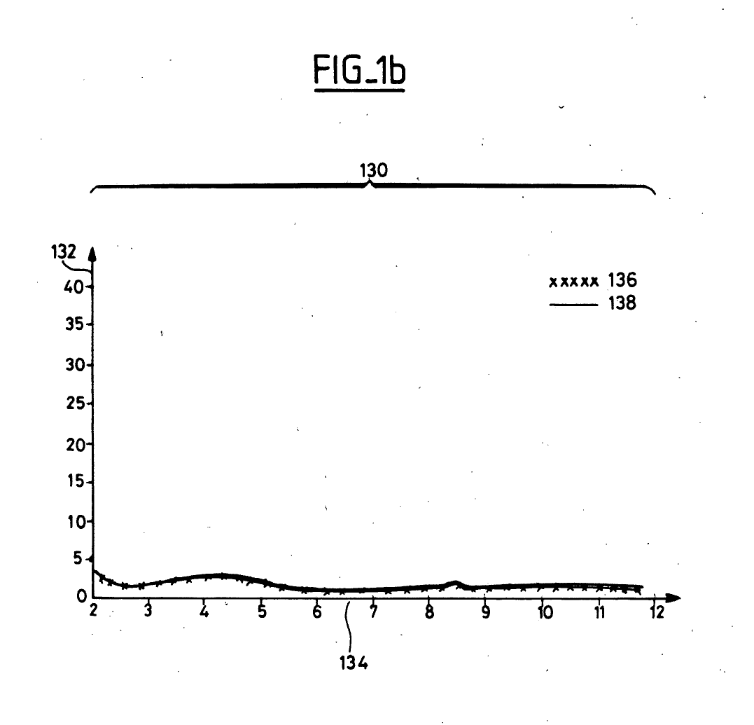

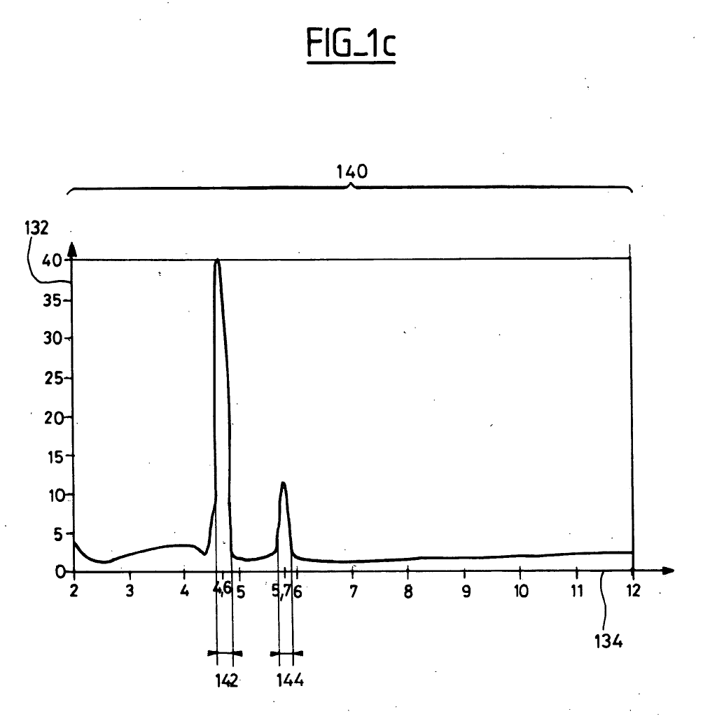

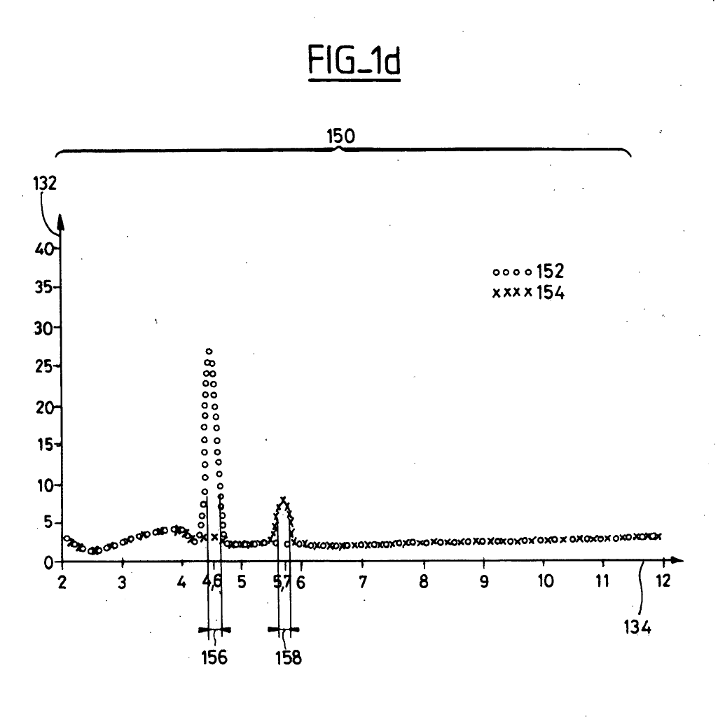

FIG. 1a represents an embodiment of a radiating device of an antenna in accordance with the invention,

FIGS. 1b, 1c and 1d represent simulations of the standing wave ratio of a radiating device in accordance with the invention,

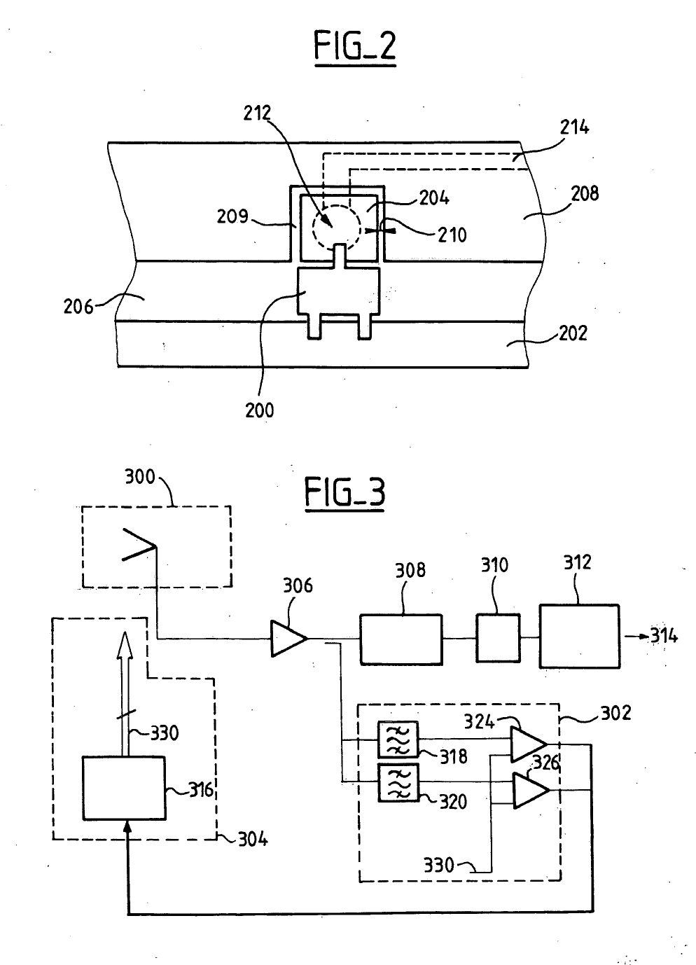

FIG. 2 diagrammatically represents switching means for a device in accordance with the invention and

FIG. 3 diagrammatically represents the detection means and the control means associated with an antenna in accordance with the invention.

FIG. 1 represents an embodiment of a radiating device 100 of an antenna in accordance with the invention. In this embodiment, the radiating device 100 comprises a dipole. This broadband radiating device 100 comprises two circular arms 106 and 107.

The diameter of the circular arms is 24 mm while they are separated from one another by a distance of 1 mm. These circular arms are made of a conducting material or are covered with a conducting material.

The feed for these circular arms is effected through the connection points 126 and 128.

Two rejector filters have been integrated with this radiating device 100.

The first is situated around a frequency of 4.6 GHz: it is called the low-frequency filter or LF filter.

This filter is made by two nonconducting parts 104 and 110, each having a length 32 mm and a width of 0.5 mm.

These two nonconducting parts 104 and 110 are bridged by LF means 116 and 122 of switching which can be open or dosed. If these LF switching means 116 and 122 are open, these LF switching means 116 and 122 are not conducting and the LF rejector filter is active around a frequency of 4.6 GHz.

If these LF means 116 and 122 are dosed, these LF means 116 and 122 of switching are conducting, then making the 4.6 GHz rejector filter disappear.

The second rejector filter is situated around a frequency of 5.7 GHz: it is called the high-frequency filter or HF filter. It comprises two nonconducting parts 102 and 108, each having a length 26 mm and a width of 0.4 mm.

These two nonconducting parts 102 and 108 are bridged by HF means 118 and 120 of switching which can be open or dosed. If these HF means 118 and 120 of switching are open, these HF means 118 and 120 of switching are not conducting and the HF rejector filter is active around a frequency of 5.7 GHz.

If these HF means 118 and 120 of switching are dosed, these HF means 118 and 120 of switching are conducing, thus making the 5.7 GHz rejector filter disappear.

When the HF means 118 and 120 and the LF means 116 and 122 are dosed (also termed active), the two rejector filters are deactivated and the radiating device 100 behaves as a dipole without rejector filter (in particular without nonconducting parts 102, 104, 108 or 110).

When the LF means 116 and 122 are dosed and the HF means 118 and 120 are open (also termed inactive), then a rejection filter is active at high frequency (around 5.7 GHz).

When the LF means 116 and 122 are open and the HF means 118 and 120 are dosed, then a rejection filter is active at low frequency (around 4.6 GHz).

When the LF means 116 and 122 are open and the HF means 118 and 120 are open, then a rejection filter is active at low frequency (around 4.6 GHz) and a rejection filter is active at high frequency (around 5.7 GHz).

The LF means 116, the LF means 122, the HF means 118 and the HF means 120 each comprise at least one diode, a micro-electromechanical system or any other system that can be controlled so as to be open or dosed, that is to say respectively nonconducting or conducing.

All these results are validated by simulations. FIGS. 1b, 1c and 1d are examples of the results obtained.

FIG. 1b is a chart 130 giving the curve of the standing wave ratio called VSWR (“Voltage Standing Wave Ratio”) of the device 100 of FIG. 1a as ordinate 132 as a function of frequency in GHz as abscissa 134 over a frequency span of [2 GHz-12 GHz].

Curve 136 is that obtained with a radiating device without rejection filter.

Curve 138 is obtained with a radiating device 100 integrating the nonmetallized parts 102, 104, 108 and 110, the means 116, 118, 120 and 122 of switching being dosed (also termed conducting).

Note that the two curves are superimposed, thereby showing that the rejector filters of the radiating device 100 are completely cancelled. The device 100 then behaves as a radiating device without nonmetallic parts. This device 100, and therefore the antenna into which it is integrated, then suffers no loss of passband when its rejector filters are deactivated.

FIG. 1c represents the chart 140 giving the VSWR ratio as ordinate 132 as a function of frequency in GHz (as abscissa 134), in a manner analogous to FIG. 1b, in the case where the means 116, 118, 120 and 122 of switching are open (also termed nonconducting).

Note the significant value of the VSWR ratio for narrow spans 142 and 144 of frequencies around the values 4.6 GHz and 5.7 GHz, thereby involving strong rejection for these spans 142 and 144.

The two rejector filters therefore carry out their rejection functions for spans 142 and 144 of frequencies.

FIG. 1d is a chart 150 giving:
Curve 152 of VSWR ratio as ordinate 132 as a function of frequency in GHz (as abscissa 134) for LF switching means 116 and 122 open: the LF rejector filter is active around a frequency of 4.6 GHz and the VSWR ratio is significant in a narrow band 156 around 4.6 GHz.
Curve 154 of VSWR ratio as ordinate 132 as a function of frequency in GHz (as abscissa 134) for HF switching means 118 and 120 open (LF switching means 116 and 122 dosed): the HF rejector filter is active around a frequency of 5.7 GHz and the VSWR ratio is significant in a narrow band 158 around 5.7 GHz.

Thus, the simulation makes it possible to verify the possibility of activating either the LF rejector filter, or the HF rejector filter independently.

FIG. 2 is a diagrammatic representation of an embodiment of the switching means for an embodiment of the radiating device on a printed circuit.

The two circular arms of the radiating device are then etched on a face. A part is nonmetallized to create the rejector filters.

In this embodiment, a surface-mounted diode 200, soldered to a first metallic part 202 of a circular arm and a second metallic part 204, bridges a nonmetallized part 206 having a dielectric constant eR.

The metallic part 204 is separated from the metallic part 208 by a channel 209 of dielectric which surrounds it This channel has a channel width 210.

This width 210 of channel disables the continuous current transmission necessary for the control of the diode which can arrive through the metallic part 208 and which could disturb the operation of the diode.

But this width 210 of channel allows the high-frequency signal to pass through. Another possible embodiment consists in putting in place capacitors, between the metallic parts 208 and 204, these capacitors being able to effect the same function.

The DC feed of the diodes is ensured by a via 212 and a line 214.

FIG. 3 diagrammatically represents means 302 of detection and means 304 of control associated with the radiation device 300 in accordance with the invention.

The signal originating from the device 300 is dispatched to the amplifier 306, dubbed LNA (“Low Noise Amplificator”, that is to say amplifier improving the signal-to-noise ratio).

Thereafter, the signals specific to the device 300, such as for example the UWB signals, pass into a correlator 308 which makes it possible to retrieve the information, then into an analogue-digital converter 310.

Thereafter, the data are processed in baseband in means 312 of management so as to provide data 314.

Moreover, means 302 for detecting interfering signals are also connected to the output of the LNA 306. These means 302 of detection contain a battery of filters 318 and 320, equal in number to the number of rejector filters present in the radiating element 300 which in this embodiment is equal to two. Each of these filters 318 and 320 analyses the frequencies, termed frequencies to be monitored, for which rejector filters have been created in the device 300 in anticipation of interfering signals.

The means 302 of detection also contain comparators 324 and 326 which compare the power of the detected interfering signals with a threshold 330.

If the power of the interfering signals is below this threshold 330, no action is taken. If this power exceeds the threshold 330 for one or more frequencies to be monitored, then the detection means communicate this information to means 304 of control, so as to open the corresponding switching means at the level of the device 300.

If this power should then drop below the threshold 330, then the detection means communicate this information to the control means 304, so as to dose the corresponding switching means.

These control means contain a PROM (“Programmable Readable Only Memory”) memory 316.

The PROM memory 316 controls the switching means present in the device 300 (cf. FIG. 1) to cancel or operate the associated rejector filters through a control bus 330 (the voltage delivered corresponds either to a “0” bit or to a “1” bit) via a biasing circuit.

The other access of each of the switching means is connected to the metallic part of the circular arm of the dipole, and is linked to the PROM memory by an earth wire.

This particular embodiment therefore uses two control wires plus an earth wire per arm, that is to say six wires in total.

This invention is amenable to multiple variants. In particular, the number of rejector filters can be variable (one only, two as in the preceding embodiment or greater than two).

Moreover, the shape of the filters can be variable. The circular shape of the embodiment cited above is only one possibility. Specifically the invention can be embodied with other shapes as a function of the requirements of integration of several filters.

This solution is usable at reception to avoid loss of information, but also on emission to eliminate particular preselected or switchable frequency bands which may be perturbed by the signals emitted by the radiating device, and more widely by the antenna.

1. Antenna comprising at least one radiating device, with a rejector filter associated with a frequency band of an interfering signal, wherein this rejector filter is adaptive, so as to be active when the interfering signal is detected and its power is above a threshold, this adaptive filter being deactivated when the detected power of this interfering signal is below the threshold.

2. Antenna according to claim 1, wherein it is able to receive or to transmit signals in the frequency band of [3.1 GHz; 10.6 GHz].

3. Antenna according to claim 1 wherein the rejector filter comprises at least one nonconducting part in at least one of the radiating devices.

4. Antenna according to claim 3, wherein the nonconducting part has a dimension equal to half the central wavelength of an interfering signal that it is desired to filter for reception or to protect for transmission, if this signal is detected.

5. Antenna according to claim 3 wherein the nonconducting part is bridged by switching means linking its conducting edges.

6. Antenna according to claim 5, wherein the switching means comprise a diode or an electromechanical system.

7. Antenna according to claim 1 wherein means of detection of an interfering signal are associated with the antenna.

8. Antenna according to claim 7, wherein the means of detection comprise at least one comparator for comparing the level of the interfering signal with the threshold associated with this signal.

9. Antenna according to claim 5, wherein means of control of the switching means are associated with the antenna.

10. Antenna according to claim 9, wherein the control means open the switching means associated with an interfering signal when the power of this interfering signal exceeds the threshold associated with this signal.

11. Antenna according to claim 9, wherein the control means (304) close the switching means (116, 118, 120, 122) associated with an interfering signal when the power of this interfering signal drops below the threshold associated with this signal.

12. Antenna according to claim 1, wherein the antenna is embodied on a printed circuit.

13. Antenna according to claim 1, wherein the radiating device is a dipole comprising two radiating elements.

14. Antenna according to claim 1, wherein the radiating elements have a circular or elliptical shape.

15. Antenna according to claim 1, wherein the radiating device comprises at least two rejector filters.

16. Radiating device furnished with a rejector filter, wherein the rejector filter is adaptive so as to be implemented in an antenna according to claim 1.
